(19) United States
(12) Patent Application Publication
(10) Pub. No.: US 2025/0193767 A1
(43) Pub. Date: Jun. 12, 2025

(54) DATA COLLECTION FROM USER EQUIPMENT ON USER EQUIPMENT ROUTE SELECTION POLICY USAGE

(71) Applicant: Telefonaktiebolaget LM Ericsson (publ), Stockholm (SE)

(72) Inventors: Antonio INIESTA GONZALEZ, Madrid (ES); Miguel Angel MUÑOZ DE LA TORRE ALONSO, Madrid (ES)

(73) Assignee: Telefonaktiebolaget LM Ericsson (publ), Stockholm (SE)

(21) Appl. No.: 18/843,270

(22) PCT Filed: Mar. 29, 2023
(86) PCT No.: PCT/IB2023/053146

§ 371 Date: Sep. 2, 2024

(30) Foreign Application Priority Data
Mar. 29, 2022 (EP) 22382298.2

(51) Int. Cl. H04W 40/12; H04W 24/08; H04W 28/12

(52) U.S. Cl. CPC H04W 40/12; H04W 24/08; H04W 28/12

(57) ABSTRACT

A method performed by a first network node (401, 1108, 1300, 1500) for collection from a user equipment, UE, of UE data about UE route selection policy, URSP, usage is provided. The method includes requesting (803) from the UE the UE data about URSP usage via a URSP rule between the first network node and the UE. The method further includes initiating (805) a UE policy update to update the URSP rule provided to the UE; and receiving (809) from the UE the UE data about URSP usage based on a UE policy delivery protocol that allows the UE to send the UE data about URSP usage via non-access stratum, NAS, signaling.

### TECHNICAL FIELD

The present disclosure relates generally to methods for data collection from user equipment (UE) UE route selection policy (URSP) usage based on non-access stratum (NAS) signaling, and related devices and nodes.

### BACKGROUND

FIG. 1 depicts an example of a wireless communication system 100 represented as a fifth generation (5G) network architecture composed of core network functions (NFs), where interaction between any two NFs is represented by a point-to-point reference point/interface.

Seen from the access side, the 5G network architecture shown in FIG. 1 includes a plurality of UEs connected to either a Radio Access Network (RAN) or an Access Network (AN) by a wireless interface as well as an Access and Mobility Management Function (AMF). Typically, the R(AN) comprises base stations, such as evolved Node Bs (eNBs) or 5G base stations (gNBs) or similar. Seen from the core network side, the 5G core NFs (also referred to herein as core network nodes) shown in FIG. 1 include a Network Slice Selection Function (NSSF), a Network Exposure Function (NEF), a Network Function Repository Function (NRF), an Authentication Server Function (AUSF), a Unified Data Management (UDM), an AMF, a Session Management Function (SMF), a Policy Control Function (PCF), and an Application Function (AF).

FIG. 2 depicts an example of a third generation partnership project (3GPP) 5G core (5GC) architecture for policy, charging and analytics. The 5GC policy architecture shown in FIG. 2 includes a plurality of core network nodes connected to a user plane function (UPF) by a wireless interface. The core network nodes shown in FIG. 2 include an AMF, an SMF, a Unified Data Repository (UDR), a NEF, Network Data Analytics Function (NWDAF), an AF, a PCF, and a Charging Function (CHF).

A NWDAF represents an operator managed network analytics logical function. The NWDAF is part of the architecture specified in 3GPP TS 23.501 V17.4.0 and uses the mechanisms and interfaces specified for 5GC and Operations, Administration and Maintenance (OAM).

The NWDAF interacts with different entities for different purposes including, e.g., data collection based on event subscription, provided by an AMF, SMF, PCF, UDM, AF (directly or via a NEF), and OAM; retrieval of information from data repositories (e.g., from a UDR via a UDM for subscriber-related information); retrieval of information about NFs (e.g., about a NRF for NF-related information, and NSSF for slice-related information); and/or on demand provision of analytics to consumers.

The PCF supports a unified policy framework to govern the network behavior including that the PCF provides UE Policies to the UE through the AMF.

The AMF manages UE access (e.g., when a UE is connected through different access networks) and UE mobility aspects, including that the AMF is used for transparent delivery of UE Policies from the PCF to the UE.

3GPP TS 23.288 V 17.4.0 defines a procedure for the NWDAF to collect data from a UE Application to use as input in the generation of analytics. The data collected is data from the UE Application but not UE data (e.g., UE operating system (OS) data or modem data). The NWDAF may interact with an AF to collect the UE Application data from UE Application(s). The UE Application establishes a connection to the AF in the mobile network operator (MNO) domain or external to a MNO domain over a user plane via a packet data unit (PDU) session. The AF communicates with the UE Application and collects UE Application data from the UE Application.

A URSP is related to UE applications and PDU sessions. The URSP includes information mapping certain UE data traffic for applications to 5G PDU Session connectivity parameters. The UE data traffic is defined in a URSP rule by a “traffic descriptor” parameter that can include, e.g., filter parameters or Application Identity. The URSP may be used by the UE to determine if an application started in the UE can be using an already established PDU Session or there is a need to trigger the establishment of a new PDU Session. The URSP also indicates to the UE whether the application traffic can be offloaded to non-3GPP access outside a PDU Session.

### SUMMARY

There currently exist certain challenge(s). A process for obtaining information from UEs about whether and how URSPs are used by the UEs for the mapping of applications into PDU sessions may be lacking. 3GPP TS 23.288 V 17.4.0 includes an approach for collecting UE application data; however, the approach lacks collection of data from the UE itself (e.g., UE OS or UE modem).

Another approach (referred to herein as approach #28 in 3GPP TR 23.700-91 V 17.0.0 related to Key Issue #8 “UE data as an input for analytics generation”), proposes UE direct communication to a NWDAF over NAS. This may be a difficult task, however. Although there is a generic mechanism for a NF to send and receive messages (e.g., NAS message containers) to/from the UE by using AMF and Namf_Communication services, potential difficulties include without limitation: The definition of a completely new protocol between the UE and NWDAF; support for this new protocol into Namf_Communication services, which may have impacts in an AMF; a need for the NWDAF to be notified when the UE is registered/deregistered including the notification of the AMF serving the UE. For some cases of AMF handover, the NWDAF may need to be notified about the change of AMF; and/or, in some cases, the data collected from the UE may be needed directly in the PCF, instead of the analytics provided by the NWDAF. If so, this a new interface provided by the NWDAF may be needed to provide such data (e.g., and not the analytic derived from them) to the PCF.

Certain aspects of the disclosure and their embodiments may provide solutions to these or other challenges. A method is provided for data collection from a UE through NAS signaling with a URSP (e.g., by extending a URSP and the existing mechanism for UE Policy delivery protocol (UPDP) between the PCF and the UE). This may enable a core network node (e.g., a PCF) to request from a UE(s) a report of URSP usage with the same mechanism used to deliver the URSPs to the UEs and for the UE to deliver URSP usage reports (e.g., with extended procedures in that protocol). Moreover, the core network node (e.g., PCF) may expose the data collected from the UE(s) (e.g., to a NWDAF) through a new event (e.g., in in Npcf_EventExposure).

Certain embodiments may provide one or more of the following technical advantage(s). The method of the present disclosure may allow a network operator to request and collect data from a UE about URSP usage in a simple and efficient way. The method may be a more efficient process than existing approaches, e.g. approach #28 in 3GPP TR 23.700-91 V 17.0.0, to collect data from the UE about URSP usage and to expose this data to another core network node (e.g., a NWDAF) based on extending existing event exposure functionality (e.g., existing PCF event exposure functionality). Additionally, the method of the present disclosure may allow a core network node (e.g., a PCF) to know per each registered UE (per every UE policy association) what URSPs and route selection descriptors (RSDs) have been selected for the different applications used by the UE during that registration. This may allow quick reaction in the core network node (e.g., PCF) to update URSP rules per each UE when needed.

In some embodiments, a method performed by a first network node for collection from a UE of UE data about URSP usage is provided. The method includes requesting from the UE the UE data about URSP usage via a URSP rule between the first network node and the UE. The method further includes initiating a UE policy update to update the URSP rule provided to the UE; and receiving from the UE the UE data about URSP usage based on a UE policy delivery protocol that allows the UE to send the UE data about URSP usage via non-access stratum, NAS, signaling.

In some embodiments, a first network node in a communications system is provided. The first network node includes processing circuitry; and memory coupled with the processing circuitry. The memory includes instructions that when executed by the processing circuitry causes the first network node to perform operations for collection from a UE of UE data about URSP usage. The operations include request from the UE the UE data about URSP usage via a URSP rule between the first network node and the UE. The operations further include initiate a UE policy update to update the URSP rule provided to the UE; and receive from the UE the UE data about URSP usage based on a UE policy delivery protocol that allows the UE to send the UE data about URSP usage via non-access stratum, NAS, signaling.

In some embodiments, a first network node in a communications system is provided. The first network node is adapted to perform operations for collection from a UE of UE data about URSP usage. The operations include request from the UE the UE data about URSP usage via a URSP rule between the first network node and the UE. The operations further include initiate a UE policy update to update the URSP rule provided to the UE; and receive from the UE the UE data about URSP usage based on a UE policy delivery protocol that allows the UE to send the UE data about URSP usage via non-access stratum, NAS, signaling.

In some embodiments, a computer program comprising program code to be executed by processing circuitry of a first network node in a communication system is provided. Execution of the program code causes the first network node to perform operations for collection from a UE of UE data about URSP usage. The operations include request from the UE the UE data about URSP usage via a URSP rule between the first network node and the UE. The operations further include initiate a UE policy update to update the URSP rule provided to the UE; and receive from the UE the UE data about URSP usage based on a UE policy delivery protocol that allows the UE to send the UE data about URSP usage via non-access stratum, NAS, signaling.

In some embodiments, a computer program product comprising a non-transitory storage medium including program code to be executed by processing circuitry of a first network node in a communication system is provided. Execution of the program code causes the first network node to perform operations for collection from a UE of UE data about URSP usage. The operations include request from the UE the UE data about URSP usage via a URSP rule between the first network node and the UE. The operations further include initiate a UE policy update to update the URSP rule provided to the UE; and receive from the UE the UE data about URSP usage based on a UE policy delivery protocol that allows the UE to send the UE data about URSP usage via non-access stratum, NAS, signaling.

In some embodiments, a method performed by a UE for providing UE data about URSP usage is provided. The method includes receiving a request for the UE data about URSP usage via a URSP rule between a first network node and the UE. The method further includes checking whether the URSP rule includes information indicating to the UE whether and how to send to the first network node the UE data about URSP usage. The method further includes, based on inclusion of the information in the URSP rule, signaling via non-access stratum, NAS, signaling the UE data about URSP usage to the first network node.

In some embodiments, a UE in a communication system is provided. The UE includes processing circuitry; and memory coupled with the processing circuitry. The memory includes instructions that when executed by the processing circuitry causes the UE to perform operations for providing UE data about URSP usage. The operations include receive a request for the UE data about URSP usage via a URSP rule between a first network node and the UE. The operations further include check whether the URSP rule includes information indicating to the UE whether and how to send to the first network node the UE data about URSP usage. The operations further include, based on inclusion of the information in the URSP rule, signaling via non-access stratum, NAS, signaling the UE data about URSP usage to the first network node.

In some embodiments, a UE in a communication system is provided that is adapted to perform operations. The operations include receive a request for the UE data about URSP usage via a URSP rule between a first network node and the UE. The operations further include check whether the URSP rule includes information indicating to the UE whether and how to send to the first network node the UE data about URSP usage. The operations further include, based on inclusion of the information in the URSP rule, signaling via non-access stratum, NAS, signaling the UE data about URSP usage to the first network node.

In some embodiments, a computer program comprising program code to be executed by processing circuitry of a UE in a communication system is provided. Execution of the program code causes the UE to perform operations for providing UE data about URSP usage. The operations include receive a request for the UE data about URSP usage via a URSP rule between a first network node and the UE. The operations further include check whether the URSP rule includes information indicating to the UE whether and how to send to the first network node the UE data about URSP usage. The operations further include, based on inclusion of the information in the URSP rule, signaling via non-access stratum, NAS, signaling the UE data about URSP usage to the first network node.

In some embodiments, a computer program product comprising a non-transitory storage medium including program code to be executed by processing circuitry of a UE in a communication system is provided. Execution of the program code causes the UE to perform operations for providing UE data about URSP usage. The operations include receive a request for the UE data about URSP usage via a URSP rule between a first network node and the UE. The operations further include check whether the URSP rule includes information indicating to the UE whether and how to send to the first network node the UE data about URSP usage. The operations further include, based on inclusion of the information in the URSP rule, signaling via non-access stratum, NAS, signaling the UE data about URSP usage to the first network node.

In some embodiments, a method performed by a second network node for collecting UE data about URSP usage is provided. The method includes signalling a request towards a first network node to subscribe to an event for the UE data about the URSP usage; and receiving a message from the first network node comprising an exposure of the requested UE data about URSP usage.

In some embodiments, a second network node in a communications system is provided. The second network node includes processing circuitry; and memory coupled with the processing circuitry. The memory includes instructions that when executed by the processing circuitry causes the second network node to perform operations for collection of UE data about URSP usage. The operations include signal a request towards a first network node to subscribe to an event for the UE data about the URSP usage; and receive a message from the first network node comprising an exposure of the requested UE data about URSP usage.

In some embodiments, a second network node in a communications system is provided that is adapted to perform operations for collection of UE data about URSP usage. The operations include signal a request towards a first network node to subscribe to an event for the UE data about the URSP usage; and receive a message from the first network node comprising an exposure of the requested UE data about URSP usage.

In some embodiments, a computer program comprising program code to be executed by processing circuitry of a second network node in a communication system is provided. Execution of the program code causes the second network node to perform operations for collection of UE, data about URSP usage. The operations include signal a request towards a first network node to subscribe to an event for the UE data about the URSP usage; and receive a message from the first network node comprising an exposure of the requested UE data about URSP usage.

In some embodiments, a computer program product comprising a non-transitory storage medium including program code to be executed by processing circuitry of a second network node in a communication system is provided. Execution of the program code causes the second network node to perform operations for collection of UE data about URSP usage. The operations include signal a request towards a first network node to subscribe to an event for the UE data about the URSP usage; and receive a message from the first network node comprising an exposure of the requested UE data about URSP usage.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram depicting an example of a wireless communication system;

FIG. 2 is a block diagram depicting an example of a 3GPP 5GC architecture for policy, charging and analytics;

FIG. 3 is a signaling diagram showing an example of UPDP procedures;

FIG. 4 is a flowchart illustrating operations of a first network node in accordance with some embodiments of the present disclosure;

FIG. 5 is a signaling diagram illustrating an example embodiment of a UPDP protocol in accordance with some embodiments of the present disclosure;

FIGS. 6A and 6B collectively form FIG. 6 and is a sequence diagram for an example embodiment of collecting UE data on URSP usage from a UE in accordance with some embodiments of the present disclosure;

FIG. 7 is a sequence diagram for another example embodiment of collecting UE data on URSP usage from a UE in accordance with some embodiments of the present disclosure;

FIG. 8 is a flow chart illustrating operations of a first network node in accordance with some embodiments of the present disclosure;

FIG. 9 is a flow chart illustrating operations of a UE in accordance with some embodiments of the present disclosure;

FIG. 10 is a flow chart illustrating operations of a second network node in accordance with some embodiments of the present disclosure;

FIG. 11 is a block diagram of a communication system in accordance with some embodiments;

FIG. 12 is a block diagram of a UE (e.g., UE 403) in accordance with some embodiments;

FIG. 13 is a block diagram of a network node (e.g., first network node 401 and/or second network node 405) in accordance with some embodiments;

FIG. 14 is a block diagram of a host computer communicating with a UE in accordance with some embodiments;

FIG. 15 is a block diagram of a virtualization environment in accordance with some embodiments; and

FIG. 16 is a block diagram of a host computer communicating via a base station with a UE over a partially wireless connection in accordance with some embodiments in accordance with some embodiments.

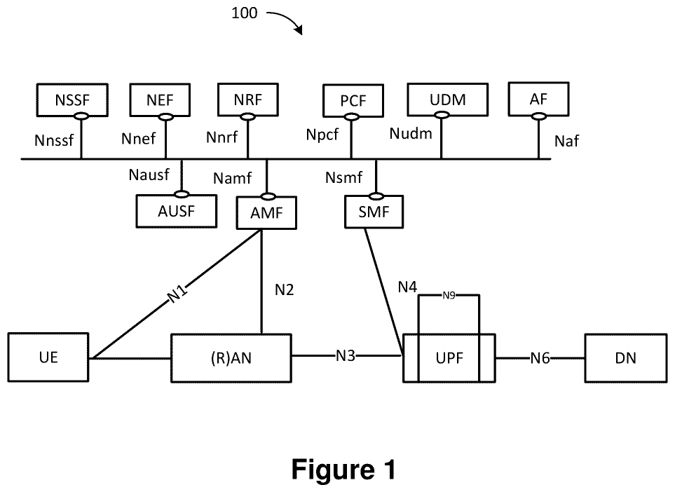

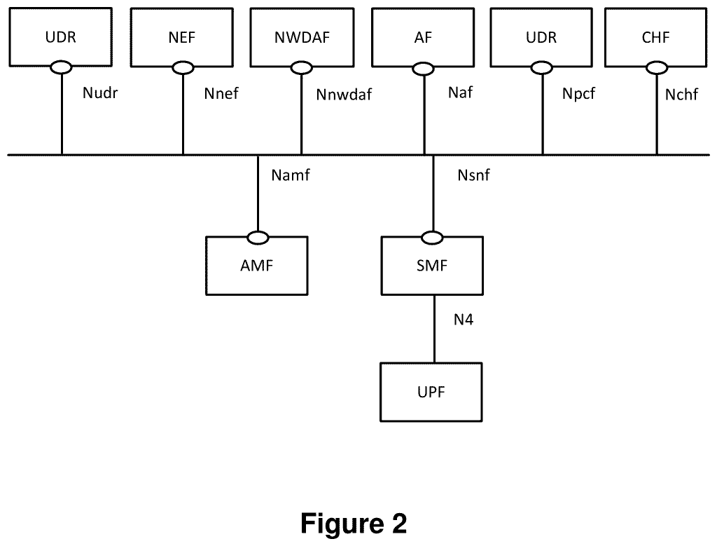

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, 3GPP TR 23.700-91 was a Release 17 study related to enhancements for analytics and NWDAF. There was a Key Issue #8 “UE data as an input for analytics generation” addressing an issue about how to support collection and utilisation of data provided by the UE in NWDAF to provide input information to generate analytics information (to be consumed by other NFs).

Different approaches were evaluated for the issue, including approach #28, which proposes that the NWDAF collects data from the UE about how the UE uses URSP rules downloaded by a PCF when PDU sessions are selected by the UE to transfer traffic from different applications. Later, the NWDAF uses these data to generate analytics (e.g., statistics and predictions) about the URSP usage in the UE, that can be consumed by the PCF to adjust the URSPs sent to the UEs.

For the collection of these data, approach #28 proposes to use a mechanism based on Control Plane reporting, where the NWDAF sends a request to the UE encapsulated in a transparent container sent from NWDAF to AMF and then AMF forwards the container to UE via NAS message. UE data reporting (that is, from the UE to the NWDAF) is also encapsulated in a transparent container sent to AMF via a NAS message and the AMF forwards the container to the NWDAF.

Approach #28 was not selected to be progressed within the scope of 3GPP Rel17. However, for Rel18 there are new study item descriptions (SIDs) including similar objectives, including the following: (1) a new SID (FS_eNA_Ph3 SID) has been approved which includes “WT #3.7 NWDAF-assisted URSP” as one of its objectives. Some examples and justification for this objective can be found in the discussion paper, S2-2107213. There is a contribution (S2-2200801) to the SA2 149 meeting from CT and Vivo (CT and Vivo were the authors of approach #28 in 3GPP TR 23.700-91 V 17.0.0) for defining a key issue (KI) in that SID related with that objective; and (2) a new SID (FS_eUPO) has been approved which includes the following objective: “#4: In 5G deployment, the operator may restrict the usage of a specific network slice (e.g. based on the combination of S-NSSAI and DNN) to some specific third party Service Provider, which can be achieved by constructing the proper URSP rule at PCF and provisioning it to UE side, but currently the 5G network does not know whether the URSP is enforced by the UE. The network may need to be made aware when an application of a third party Service Provider is routed using provisioned URSP Rules.”

As previously indicated, the method of the present disclosure may provide solutions to these or other challenges based on a first network node (e.g., a PCF) collecting UE data about URSP usage based on an extension of an existing protocol (e.g., a UPDP protocol) for UE policy delivery via NAS signaling and URSP extension. The method may further include operations for the first network node (e.g., the PCF) to expose the data collected from the UE by extending an existing event exposure process (e.g., PCF event exposure mechanism) with a new event.

As discussed further herein, the method may include an extension of URSP data to request the UE to provide data about how URSP are used by the UE for the mapping of application traffic into PDU sessions; collection of those data from the UE about URSP usage based on an extension of existing protocol between a first network node (e.g., a PCF) and UE for UE policies delivery; and/or exposure of such data about URSP usage from the first network node based on event exposure. The first network node may expose the collected data from the UE to a second network node (e.g., a NWDAF) via and event exposure mechanism (e.g., via a Npcf_EventExposure mechanism).

As described in 3GPP TS 29.523 V 17.6.0, the PCF provides the Policy Event Exposure Service, which includes allowing NF service consumers to subscribe to, modify, and unsubscribe from policy control events; and notifying NF service consumers with a corresponding subscription about observed events on the PCF. The types of observed events include public land mobile network (PLMN) identifier notification, access type change, and satellite backhaul category change.

3GPP TS 24.501 17.6.1 describes the UPDP between the PCF and the UE which is used for the delivery of UE Policies to the UEs.

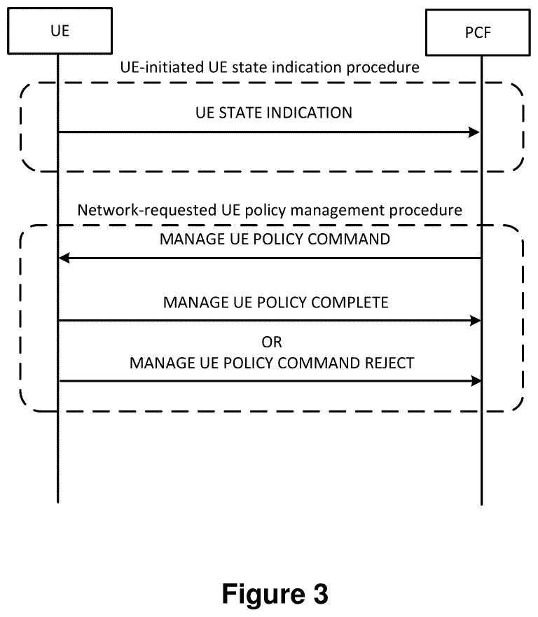

FIG. 3 depicts an example of UPDP procedures. The UPDP procedures shown in FIG. 3 include a UE-initiated UE state indication procedure, and a network-requested UE policy management procedure. The UE-initiated UE state indication procedure includes a UE signaling a UE state indication to a PCF. The network-requested UE policy management procedure includes the PCF signals a manage UE policy command to the UE. The UE signals a manage UE policy complete or a manage UE policy command reject to the PCF.

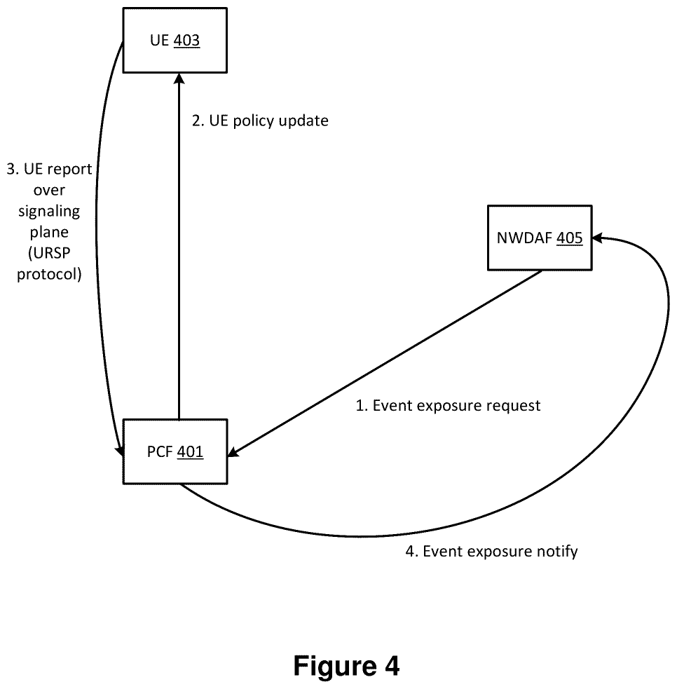

FIG. 4 is a flowchart illustrating operations of a first network node 401 (e.g., a PCF), a second network node 405 (e.g., a NWDAF), and a UE 403 in accordance with some embodiments of the present disclosure. As shown in FIG. 4, a consumer NF (e.g. a PCF) makes a request for analytics to NWDAF 405, for which NWDAF 405 needs data collection from the UE about URSP usage. In operation 1, NWDAF 405 triggers this data collection through PCF event exposure. NWDAF 405 determines what UEs (e.g., given location area, subscription permanent identifier (SUPI) group, and/or SUPI list) that should collect data. NWDAF 405 subscribes/requests to PCF 401 (e.g., using the Npcf_EventExposure service) to an event relative to UE URSP usage data.

In operation 2, PCF 401 updates the URSP for the required UE(s) adding an indication for the UE to report the information about the URSP usage.

In operation 3, UE 403 reports the requested data over a signaling plane through NAS signaling (e.g., via an extension of an existing protocol between PCF 401 and UE 403 (e.g., an extension of UPDP).

In operation 4, PCF 401 triggers towards NWDAF 405 an event exposure notification (e.g., a Npcf_EventExposure notification) for the event relative to UE URSP usage data.

While embodiments herein are explained in the non-limiting context of collecting data from the UE about URSP usage, the method of the present disclosure is not so limited. Instead, other collecting data from the UE about usage of other rules may be included, including without limitation, the usage of wireless local area network selection policy (WLANSP) rules which may be part of an access network discovery and selection policy (ANDSP). It is noted that, as with URSP rules, when a first network node (e.g., a PCF) delivers WLANSP rules to a UE, the WLANSP rules may be ordered by a precedence. The first network node may have no information about which WLANSP rule is finally selected by the UE, which one(s) is discarded, and for what reason.

Information in a URSP rule to allow the first network node 401 (e.g., a PCF) to request from the UE 401 the report of the information about usage of this URSP rule in the UE 401 for the mapping of applications into PDU sessions may include inclusion of an element in the URSP rule for usage report request information, as shown below:

URSP Rule

Rule Precedence
Traffic Descriptor
List of RSDs
Usage Report Request Information

When the usage report request element is included in the URSP rule, the element indicates to the UE whether and how to send data (e.g., reports) about consumption of this URSP rule.

The usage report request element may include the following information:

| Information | |
|---|---|
| name | Description |
| Conditions | This optional information element (IE) may indicate to the UE conditions that |
| to report | need to be met for the UE to send the UE data and/or preferences (e.g., a |
| | report). Conditions may be based on at least: Time and location of the UE |
| | when/where the UE data may be sent; and/or an access type (e.g., radio access |
| | type (RAT) for use in sending the UE data (e.g., to prioritize the sending of the |
| | UE data through a WIFI connection is available). |
| | Additional to a time and location criteria included as part of RSD, the |
| | conditions to report may include more granular validation criteria for sending |
| | the report |
| Error | This information element (IE) may indicate to the UE which are the error |
| conditions | conditions in the selection of a RSD that should be reported (e.g., non- |
| | allowed single-network slice selection assistance information (S-NSSAI)) |
| Immediate | This IE may indicate to the UE whether an immediate report is needed (e.g., |
| report | report just when the URSP rule is checked for PDU session selection) or the |
| | report can be delayed |

An existing UPDP protocol may be extended with a new procedure and operations in order to allow the UE 403 to send reports about UE URSP usage to the first network node 401 (e.g., a PCF).

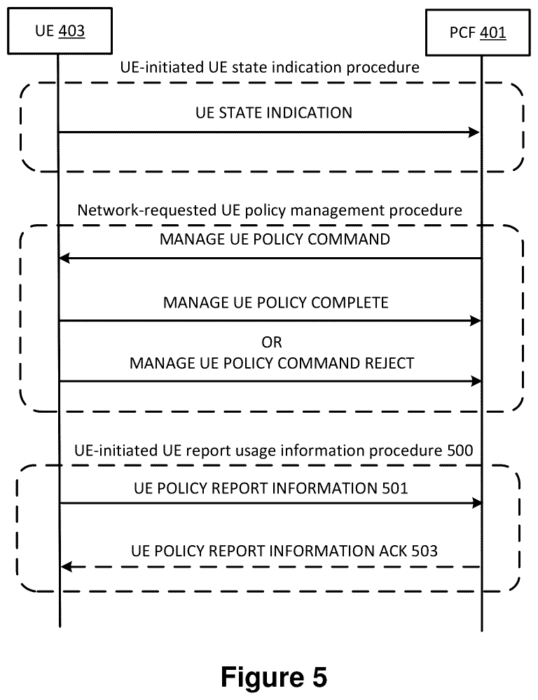

FIG. 5 is a signaling diagram illustrating an example embodiment of a UPDP protocol in accordance with some embodiments of the present disclosure. FIG. 5 includes the UE-initiated US state indication procedure and the network-requested UE policy management procedure discussed with reference to FIG. 3. FIG. 5, however, further includes a UE-initiated UE report usage information procedure. In the UE-initiated UE report usage information procedure, UE 403 signals a UE policy report information to PCF 401 and, optionally, PCF 401 may signal to UE 403 a US policy report information acknowledgement.

The UE policy report information signaled by UE 403 may include: An application identifier that is an identifier of the application that is matched with the traffic descriptors in the URSP rule(s); an identifier(s) of the RSD that was matched (e.g., there may be many). This identifier(s) may include a reason for rejection in case the information in the RSD was not finally considered for the PDU session selection of the application (e.g., not allowed S-NSSAI, error in the establishment of the PDU session, etc.); a timestamp for the URSP usage; and/or a location of the UE.

An event exposure may include an event including a report(s) from a UE about URSP usage (e.g., an extension of an existing PCF event exposure with a new event for inclusion of such report(s)). A NF consumer (e.g., a NWDAF) may still subscribe for reception of such a UE URSP report(s), including filtered per application. Thus, the NWDAF may decide to receive the UE URSP report(s) just for some applications.

The event may be included, e.g., in the table shown in section 6.1.3.18 of 3GPP 23.503 V 17.4.0, as illustrated in the following addition to the table:

| | | | | | | Availability | |
|---|---|---|---|---|---|---|---|
| | | | Availability | Availability | Availability | for N43 per | Availability |
| | | | for Rx PDU | for N5 per | for Bulk | SUPI, | for N5 per |
| | | Conditions | Session | PDU | Subscription | DNN, | UE |
| Event | Description | for reporting | (NOTE 2) | Session | (NOTE 1) | S-NSSAI | (NOTE 6) |
| UE | UE has | NWDAF | No | No | Yes | No | No |
| URSP | associated | | | | | | |
| Usage | traffic for an | | | | | | |
| Report | application | | | | | | |
| | based on a | | | | | | |
| | URSP rule | | | | | | |
| | (or use it | | | | | | |
| | but failed) | | | | | | |

An event notification may be included, e.g., in DataType PcEventNotification from 3GPP TS 29.523 V17.6.0 section 5.6.2.8 with data for UE URSP. The data for UE URSP usage may include the information received from the UE as described herein including, without limitation: An application identifier that is an identifier of the application that is matched with the traffic descriptors in the URSP rule(s); an identifier(s) of the RSD that was matched (e.g., there may be many). This identifier(s) may include a reason for rejection in case the information in the RSD was not finally considered for the PDU session selection of the application (e.g., not allowed S-NSSAI, error in the establishment of the PDU session, etc.); a timestamp for the URSP usage; and/or a location of the UE.

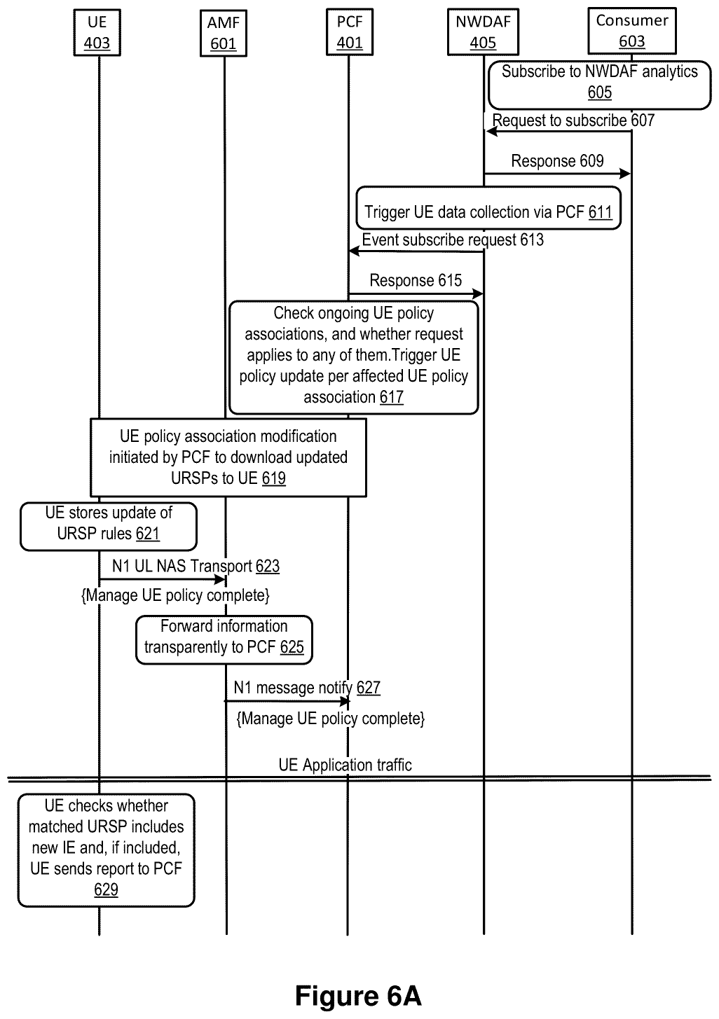

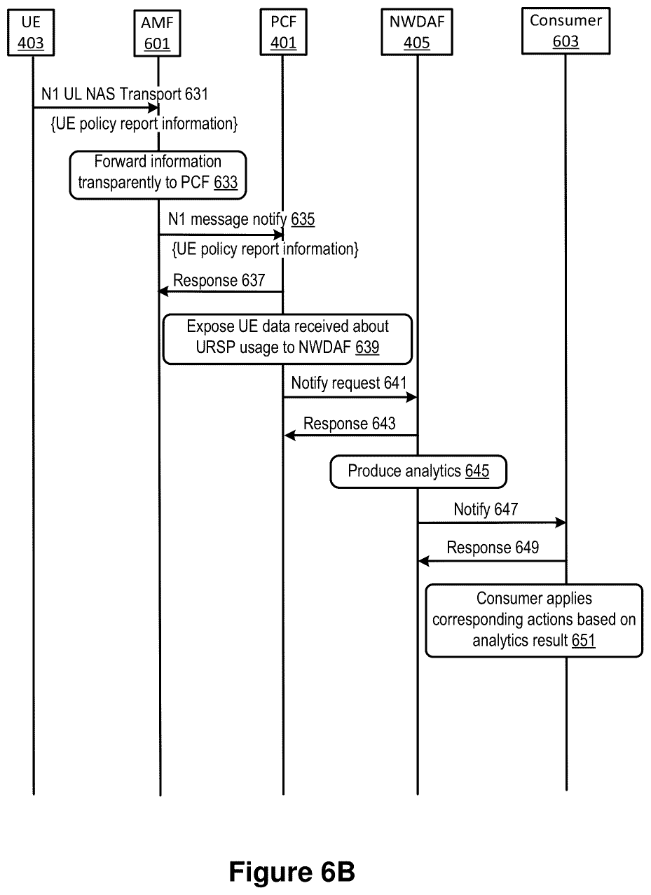

FIGS. 6A and 6B collectively form FIG. 6 and is a sequence diagram for an example embodiment of collecting UE data on URSP usage from UE 403. In the example embodiment of FIG. 6, the UE's 403 policy associations are already established; and the NWDAF 405 collects URSP enforcement information for UE 403.

In operations 605 and 607 of FIG. 6A, a consumer NF 603 (e.g. a PCF) subscribes (operation 605) to NWDAF 405 for new analytics about URSP usage consumption and triggers a Nnwdaf_AnalyticsSubscription_Subscribe request message (operation 607) including the following example parameters: an analytic identifier (e.g., URSPUsageConsumption) that indicates the analytic requested; a target of analytics (e.g., groupid), which may be a group of UES or any UE; an analytics filter, which may contain, e.g., the applications for which the analytics on URSP usage are requested.

NWDAF 405 acknowledges (operation 609) the request from operation 607.

Based on the analytic request, NWDAF 405 decides (operation 611) to trigger data collection for the group which may be done, e.g., through PCF event exposure. NWDAF 405 discovers the PCF instances handling the group and subscribes/requests to PCF 401 (e.g., using the Npcf_EventExposure service) to an event relative to a UE URSP usage report by triggering a Npcf_EventExposure_Subscribe request message (operation 613) including, e.g., the following information: an event identifier (e.g., URSP usage report), which may indicate UE data is requested; a target UE, which may indicate an identifier for the target UE; an application(s), which may optionally include a list of applications for which the report is requested.

In operation 615, PCF 401 signals a response to NWDAF 405 indicating successful operation.

PCF 401 checks (operation 617) ongoing UE Policy Associations and checks whether the request applies to any of them. For the affected UE Policy Associations, the PCF 401 executes operations 619 and 621. It is noted that for every new UE Policy Association for a UE belonging to the group included as target of event exposure (e.g., of Npcf_EventExposure) in operation 613, the PCF 401 may send updated information in the URSP rules applicable to the UE (or, e.g., just for the applications included in filter information from the NWDAF) to request URSP usage information reporting.

PCF 401 triggers UE policy update for updating the URSPs downloaded to the UE 403 including, e.g., a URSP usage report request information element (IE) if not provided yet. If a list of applications is provided as filter in operation 613, PCF 401 just updates the URSPs matching those applications. The update may follow the standard procedure for UE policy update described in 3GPP TS 23.502 V 17.4.0 section 4.16.12.2. The update of the URSP rule(s) may be performed as described herein regarding inclusion of an element in the URSP rule for usage report request information.

UE 403 stores (operation 621) the update of the URSP rule(s).

UE 403 sends (operation 623) an N1 uplink (UL) NAS Transport message to AMF 601, including a “MANAGE UE POLICY COMPLETE”.

In operations 625 and 627, AMF 601 forwards the information transparently to PCF 401 by invoking an N1 massage notify (e.g., Namf_Communication_N1MessageNotify).

In operation 629, for every new URSP query, the UE 403 checks whether the matched URSP includes the URSP request report usage information IE.

Referring now to FIG. 6B, if the URSP request report usage information IE is included, in operation 631, UE 403 sends the data to the PCF 401. The data may be a report and may include the information discussed herein regarding UE policy report information.

In operations 633 and 635, AMF 601 forwards the information transparently to PCF 401 by invoking an N1 message notify (e.g., Namf_Communication_N1MessageNotify) as may be done for any other UE Policy UE initiated message.

PCF 401 answers (operation 637) AMF 601 indicating successful operation.

In operations 639 and 641, PCF 401 exposes the UE data received about URSP usage to NWDAF 405 by triggering an event exposure notify request message (e.g., Npcf_EventExposure_Notify request message) including, e.g., the following information: an event identifier (e.g., URSP usage report); a UE identifier, which indicated the target UE; and event data, which may include the UE data. The UE data may be a URSP enforcement report that includes the information discussed herein regarding data for UE URSP usage.

NWDAF 405 signals a response (operation 643) to PCF 401 indicating successful operation.

In operation 645, NWDAF 405 produces analytics based on the UE collected data.

NWDAF 405 provides (operation 647) the analytic result to the consumer NF 603 by triggering a message (e.g., a Nnwdaf_AnalyticsSubscription_Notify message) including, e.g., the following parameters: an analytic identifier (e.g., URSPUsageConsumption); a UE identifier, which may indicate the target UE (e.g., one UE-ID within the goupld); and an analytic result, which may indicate the analytic output.

In operation 649, consumer NF 603 signals a response to NWDAF 405 indicating successful operation.

In operation 651, consumer NF 603 applies the corresponding actions based on the analytics result, e.g., if NF 603 consumer is a PCF it may use the analytic information to adjust the URSPs sent to UEs.

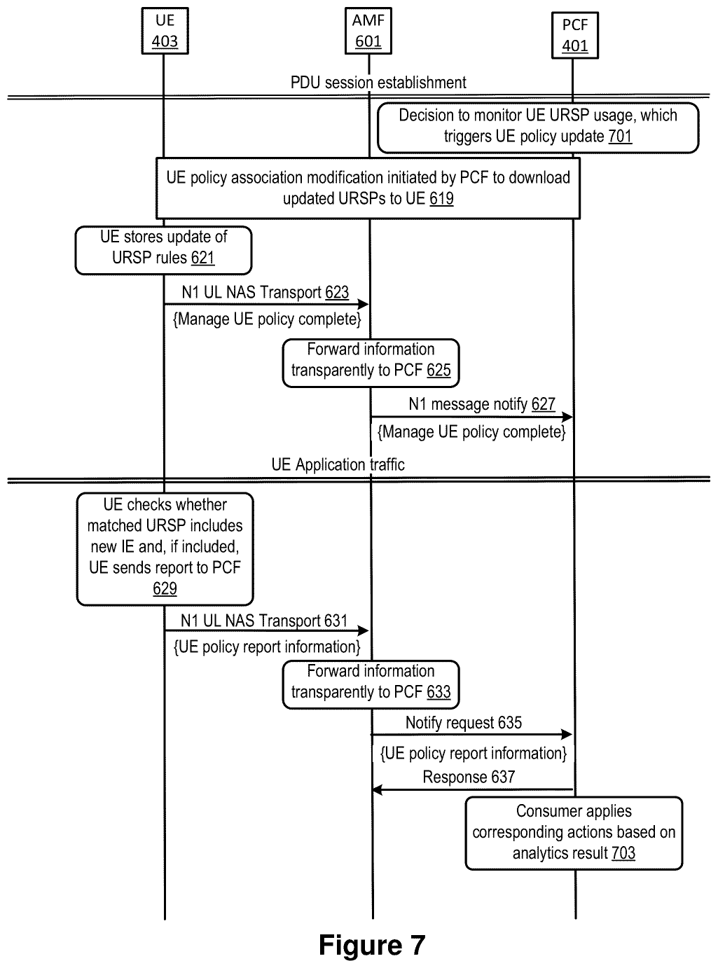

FIG. 7 is a sequence diagram for another example embodiment of collecting UE data on URSP usage from UE 403. In the example embodiment of FIG. 7, the UE's 403 policy associations are already established; and there is direct consumption in PCF 401 for URSP adjustment.

In operation 701, PCF 401 decides to monitor UE URSP usage (e.g., for all applications or just for some of them) for a specific UE or group of UEs and triggers a UE policy update.

In operation 619, PCF 401 triggers UE policy update for updating the URSPs downloaded to the UE 403 including, e.g., a URSP usage report request information element (IE) if not provided yet. If the monitoring is just for some applications, the PCF 401 just updates the URSPs matching those applications. The update may follow the standard procedure for UE policy update described in 3GPP TS 23.502 V 17.4.0 section 4.16.12.2. The update of the URSP rule(s) may be performed as described herein regarding inclusion of an element in the URSP rule for usage report request information.

UE 403 stores (operation 621) the update of the URSP rule(s).

UE 403 sends (operation 623) an N1 uplink (UL) NAS Transport message to AMF 601, including a “MANAGE UE POLICY COMPLETE”.

In operations 625 and 627, AMF 601 forwards the information transparently to PCF 401 by invoking an N1 massage notify (e.g., Namf_Communication_N1MessageNotify).

In operation 629, for every new URSP query, the UE 403 checks whether the matched URSP includes the URSP request report usage information IE.

If the URSP request report usage information IE is included, in operation 631, UE 403 sends the data to the PCF 401. The data may be a report and may include the information discussed herein regarding UE policy report information.

In operations 633 and 635, AMF 601 forwards the information transparently to PCF 401 by invoking an N1 message notify (e.g., Namf_Communication_N1MessageNotify) as may be done for any other UE Policy UE initiated message.

PCF 401 answers (operation 637) AMF 601 indicating successful operation.

In operation 703, consumer NF 603 applies the corresponding actions based on the received information (e.g., update for an ongoing UE policy association the URSPs if it detects the UE is getting some errors when applying some of the URSP/RSDs).

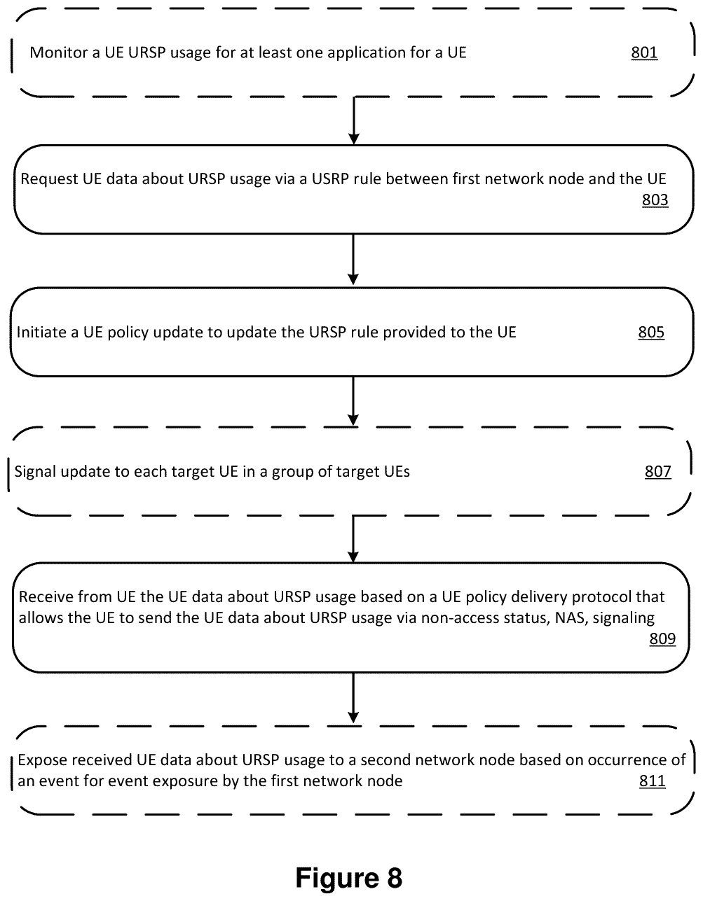

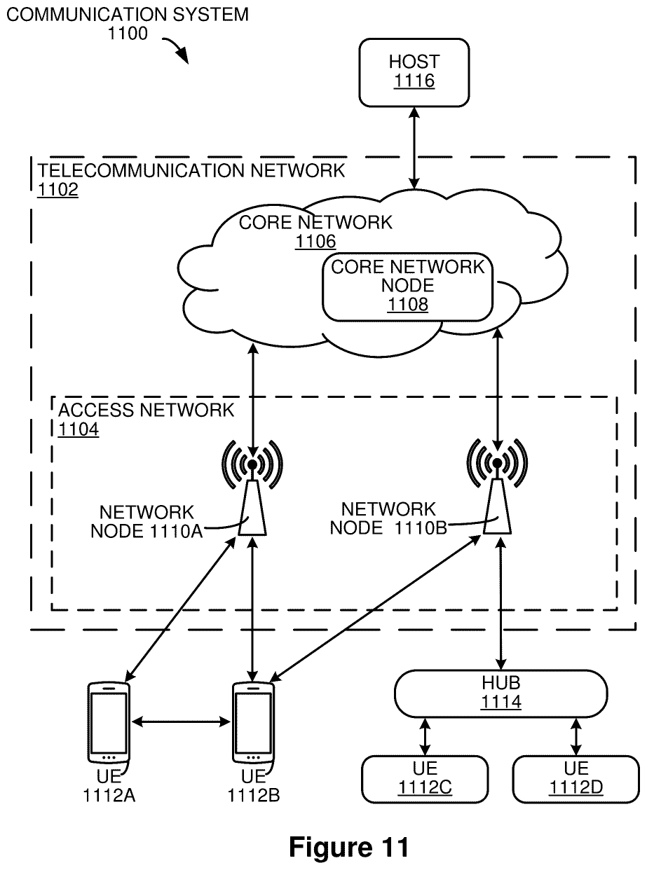

Operations of the first network node 401 (e.g., network node 1108 of FIG. 11) (implemented using the structure of 1300 of FIG. 13) will now be discussed with reference to the flow chart of FIG. 8 according to some embodiments of the present disclosure. For example, modules may be stored in memory 1304 of FIG. 13, and these modules may provide instructions so that when the instructions of a module are executed by respective first network node processing circuitry 1302, first network node 1300 performs respective operations of the flow chart.

In some embodiments, a method performed by a first network node for collection from a UE of UE data about URSP usage is provided. The method includes requesting (803) from the UE the UE data about URSP usage via a URSP rule between the first network node and the UE. The method further includes initiating (805) a UE policy update to update the URSP rule provided to the UE; and receiving (809) from the UE the UE data about URSP usage based on a UE policy delivery protocol that allows the UE to send the UE data about URSP usage via non-access stratum, NAS, signaling.

The method may further include exposing (811) the received UE data about URSP usage to a second network node based on occurrence of an event for event exposure by the first network node, the event comprising the UE has the UE data about URSP usage.

The URSP rule may comprise information indicating to the UE whether and how to send to the first network node the UE data about URSP usage.

The information may comprise at least one of the following: a condition or a list of conditions for reporting the UE data; an error condition or a list of error conditions for reporting an error in a selection of a route selection descriptor, RSD; and an indication for a timing for reporting the UE data.

The UE data about URSP usage may comprise at least one of the following: an identification of an application that is matched with a traffic descriptor in a plurality of URSP rules; an identification of the URSP rule that was matched; an identification of a route selection descriptor, RSD, that was matched, or a reason for rejection of the RSD for a packet data unit, PDU, session selection of the application; a timestamp for the URSP usage; and a location of the UE.

The requesting (803) from the UE the UE data about URSP usage via a URSP rule between the first network node and the UE may comprise receiving a request from a second network node to subscribe to an event for the UE data about the URSP usage; determining whether the request applies to an ongoing UE policy association; and initiating an update of the URSP rule for the UE with an ongoing UE policy association, the update comprising added information indicating to the UE whether and how to send to the first network node the UE data about URSP usage.

The request from the second network node may comprise at least one of the following: an identifier of the event indicating that the UE data is requested; an identifier of a group of target UEs; and an identification of at least one application for which the UE data is requested.

The added indication to the URSP rule may comprise at least one of the following: a condition for reporting the UE data; an error condition for reporting an error in a selection of a route selection descriptor, RSD, that was matched, or a reason for rejection of the RSD for a packet data unit, PDU, session selection of the application; and an indication for a timing for reporting the UE data.

The condition for reporting the UE data may comprise a time and a location of the UE when and where, respectively, the UE data may be sent and a location criteria included as part of a route selection descriptor, RSD; and/or an access type for use in sending the UE data.

In some embodiments, the method may further comprise monitoring (801) a UE URSP usage for at least one application for a UE to provide the update to the URSP rule to a group of target UEs; and signaling (807) the update to each target UE in a group of target UEs.

The update to the URSP rule may comprise adding information indicating to the UE whether and how to send to the first network node the UE data about URSP usage.

The added indication to the URSP rule may comprise at least one of the following: a condition for reporting the UE data; an error condition for reporting an error in a selection of a route selection descriptor, RSD, that was matched, or a reason for rejection of the RSD for a packet data unit, PDU, session selection of the application; and an indication for a timing for reporting the UE data.

Various operations from the flow chart of FIG. 8 may be optional with respect to some embodiments of first network nodes and related methods. For example, operations of blocks 801, 807, and 811 of FIG. 8 may be optional.

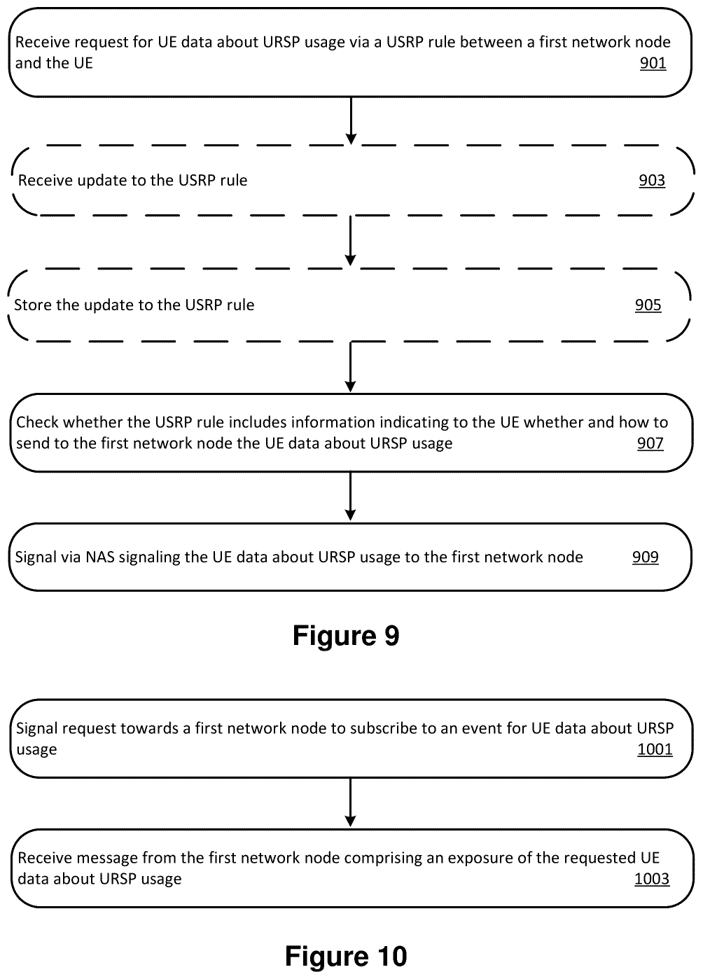

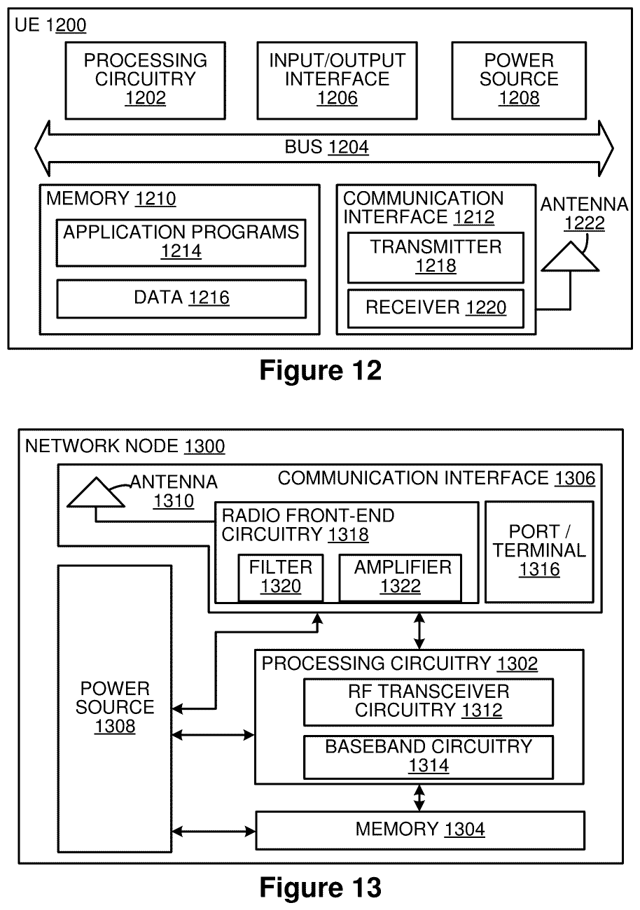

Operations of a UE 403 (e.g., UE 1112 of FIG. 11) (implemented using the structure of 1200 of the block diagram of FIG. 12) will now be discussed with reference to the flow chart of FIG. 9 according to some embodiments of inventive concepts. For example, modules may be stored in memory 1210 of FIG. 12, and these modules may provide instructions so that when the instructions of a module are executed by respective UE processing circuitry 1202, processing circuitry 1202 performs respective operations of the flow chart.

In some embodiments, a method performed by a UE for providing UE data about URSP usage is provided. The method includes receiving (901) a request for the UE data about URSP usage via a URSP rule between a first network node and the UE. The method further includes checking (907) whether the URSP rule includes information indicating to the UE whether and how to send to the first network node the UE data about URSP usage; and, based on inclusion of the information in the URSP rule, signaling (909) via non-access stratum, NAS, signaling the UE data about URSP usage to the first network node.

The information may comprise at least one of the following: a condition or a list of conditions for reporting the UE data; an error condition or a list of error conditions for reporting an error in a selection of a route selection descriptor, RSD; and an indication for a timing for reporting the UE data.

The UE data about URSP usage may comprise at least one of the following: an identification of an application that is matched with a traffic descriptor in a plurality of URSP rules; an identification of the URSP rule that was matched; an identification of a route selection descriptor, RSD, that was matched, or a reason for rejection of the RSD for a packet data unit, PDU, session selection of the application; a timestamp for the URSP usage; and a location of the UE.

In some embodiments, the method further comprises receiving (903) an update to the URSP rule; and storing (905) the update to the URSP rule.

The update may comprise information indicating to the UE whether and how to send to the first network node the UE data about URSP usage.

The information may comprise at least one of the following: a condition for reporting the UE data; an error condition for reporting an error in a selection of a route selection descriptor, RSD, that was matched, or a reason for rejection of the RSD for a packet data unit, PDU, session selection of the application; and an indication for a timing for reporting the UE data.

The condition for reporting the UE data may comprise a time and a location of the UE when and where, respectively, the UE data may be sent and a location criteria included as part of a route selection descriptor, RSD; and/or an access type for use in sending the UE data.

Various operations from the flow chart of FIG. 9 may be optional with respect to some embodiments of UEs and related methods. For example, operations of blocks 903 and 905 of FIG. 9 may be optional.

Operations of the second network node 405 (e.g., network node 1108 of FIG. 11) (implemented using the structure of 1300 of FIG. 13) will now be discussed with reference to the flow chart of FIG. 10 according to some embodiments of the present disclosure. For example, modules may be stored in memory 1304 of FIG. 13, and these modules may provide instructions so that when the instructions of a module are executed by respective second network node processing circuitry 1302, second network node 1300 performs respective operations of the flow chart.

In some embodiments, a method by a second network node for collecting UE data about URSP usage is provided. The method includes signalling (1001) a request towards a first network node to subscribe to an event for the UE data about the URSP usage. The method further includes receiving (1003) a message from the first network node comprising an exposure of the requested UE data about URSP usage.

The request may comprise at least one of the following: an identifier of the event indicating that the UE data is requested; an identifier of a group of target UEs; and an identification of at least one application for which the UE data is requested.

The exposure of the requested UE data about URSP usage may comprise at least one of the following: an identifier of the event for the UE data about URSP usage; an identifier of the UE for the UE data about the URSP usage; and the UE data about the URSP usage.

The UE data about the URSP usage may comprise a report of associated traffic for an application based on a URSP rule.

The UE data about the URSP usage may comprise at least one of the following: an identification of an application that is matched with a traffic descriptor in a plurality of URSP rules; an identification of the URSP rule that was matched; an identification of a route selection descriptor, RSD, that was matched, or a reason for rejection of the RSD for a packet data unit, PDU, session selection of the application; a timestamp for the URSP usage; and a location of the UE.

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108 (one or more of which may be generally referred to as core network nodes 1108). The access network 1104 includes one or more access network nodes, such as network nodes 1110a and 1110b (one or more of which may be generally referred to as network nodes 1110), or any other similar 3^{rd}Generation Partnership Project (3GPP) access node or non-3GPP access point. The network nodes 1110 facilitate direct or indirect connection of UE, such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a PCF, NWDAF, AMF, Mobile Switching Center (MSC), Mobility Management Entity (MME), Home Subscriber Server (HSS), SMF, AUSF, Subscription Identifier De-concealing function (SIDF), UDM, Security Edge Protection Proxy (SEPP), NEF, and/or a UPF.

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, eNBs and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

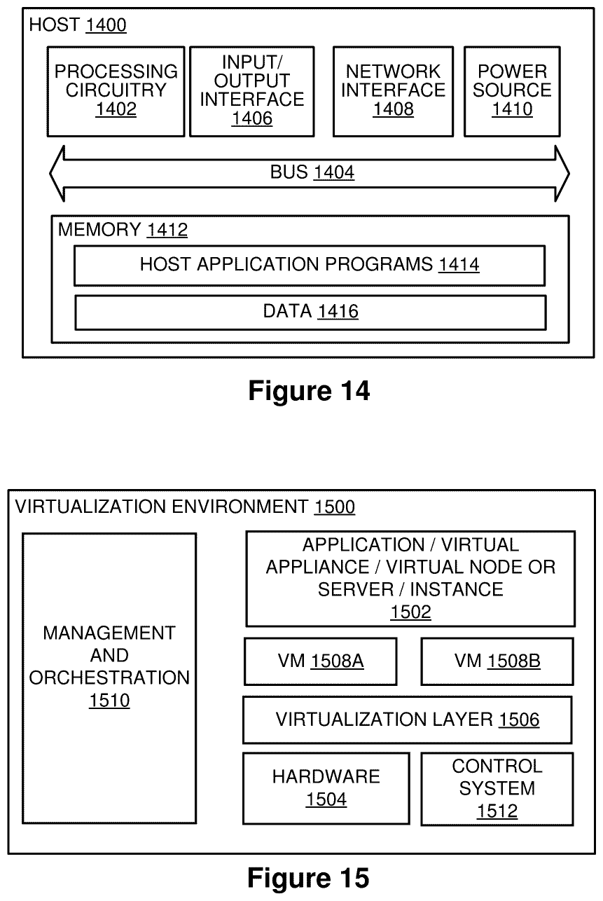

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

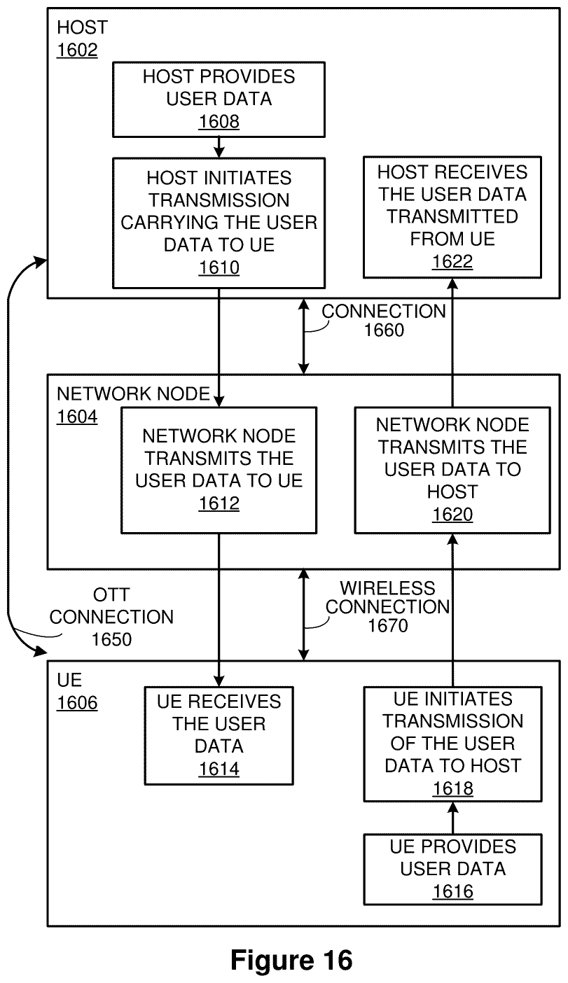

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve data collection from a UE through NAS signaling and thereby provide benefits such as enabling a core network node to request from a UE data on URSP usage with a same mechanism used to deliver the URSPs (or other rules to UEs) and for the UE to deliver URSP usage reports (or other rule usage reports); and/or enabling a core network node to expose the data collected from the UE through an event.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a first network node for collection from a user equipment, UE, of UE data about UE route selection policy, URSP, usage, the method comprising:
requesting from the UE the UE data about URSP usage via a URSP rule between the first network node and the UE;
initiating a UE policy update to update the URSP rule provided to the UE; and
receiving from the UE the UE data about URSP usage based on a UE policy delivery protocol that allows the UE to send the UE data about URSP usage via non-access stratum, NAS, signaling.

2. The method of claim 1, further comprising:
exposing the received UE data about URSP usage to a second network node based on occurrence of an event for event exposure by the first network node, the event comprising the UE has the UE data about URSP usage.

3. The method of claim 1, wherein the URSP rule comprises information indicating to the UE whether and how to send to the first network node the UE data about URSP usage.

4. The method of claim 3, wherein the information comprises at least one of the following: a condition or a list of conditions for reporting the UE data; an error condition or a list of error conditions for reporting an error in a selection of a route selection descriptor, RSD; and an indication for a timing for reporting the UE data.

5. The method of claim 1, wherein the UE data about URSP usage comprises at least one of the following: an identification of an application that is matched with a traffic descriptor in a plurality of URSP rules; an identification of the URSP rule that was matched; an identification of a route selection descriptor, RSD, that was matched, or a reason for rejection of the RSD for a packet data unit, PDU, session selection of the application; a timestamp for the URSP usage; and a location of the UE.

6. The method of claim 1, wherein the requesting from the UE the UE data about URSP usage via a URSP rule between the first network node and the UE comprises:
receiving a request from a second network node to subscribe to an event for the UE data about the URSP usage;
determining whether the request applies to an ongoing UE policy association; and
initiating an update of the URSP rule for the UE with an ongoing UE policy association, the update comprising added information indicating to the UE whether and how to send to the first network node the UE data about URSP usage.

7. The method of claim 6, wherein the request from the second network node comprises at least one of the following: an identifier of the event indicating that the UE data is requested; an identifier of a group of target UEs; and an identification of at least one application for which the UE data is requested.

8. The method of claim 6, wherein the added indication to the URSP rule comprises at least one of the following: a condition for reporting the UE data; an error condition for reporting an error in a selection of a route selection descriptor, RSD, that was matched, or a reason for rejection of the RSD for a packet data unit, PDU, session selection of the application; and an indication for a timing for reporting the UE data.

9. The method of claim 8, wherein the condition for reporting the UE data comprises a time and a location of the UE when and where, respectively, the UE data may be sent and a location criteria included as part of a route selection descriptor, RSD; or an access type for use in sending the UE data.

10. The method of claim 1 further comprising:
monitoring a UE URSP usage for at least one application for a UE to provide the update to the URSP rule to a group of target UEs; and
signaling the update to each target UE in a group of target UEs.

11. The method of claim 10, wherein the update to the URSP rule comprises adding information indicating to the UE whether and how to send to the first network node the UE data about URSP usage.

12. The method of claim 11, wherein the added indication to the URSP rule comprises at least one of the following: a condition for reporting the UE data; an error condition for reporting an error in a selection of a route selection descriptor, RSD, that was matched, or a reason for rejection of the RSD for a packet data unit, PDU, session selection of the application; and an indication for a timing for reporting the UE data.

13. The method of claim 1, wherein the first network node comprises a policy control function, PCF.

14. The method of claim 2, wherein the second network node comprises a network data analytics function, NWDAF.

15. A first network node in a communications system, the first network node comprising:
processing circuitry; and
non-transitory computer-readable memory coupled with the processing circuitry, wherein the memory includes instructions that when executed by the processing circuitry causes the first network node to perform:
requesting from a User Equipment, UE, UE data about UE route selection policy, URSP, usage via a URSP rule between the first network node and the UE;
initiating a UE policy update to update the URSP rule provided to the UE; and
receiving from the UE the UE data about URSP usage based on a UE policy delivery protocol that allows the UE to send the UE data about URSP usage via non-access stratum, NAS, signaling.

16. A method performed by a user equipment, UE, for providing UE data about UE route selection policy, URSP, usage, the method comprising:
receiving a request for the UE data about URSP usage via a URSP rule between a first network node and the UE;
checking whether the URSP rule includes information indicating to the UE whether and how to send to the first network node the UE data about URSP usage; and
based on inclusion of the information in the URSP rule, signaling via non-access stratum, NAS, signaling the UE data about URSP usage to the first network node.

17. The method of claim 16, wherein the information comprises at least one of the following: a condition or a list of conditions for reporting the UE data; an error condition or a list of error conditions for reporting an error in a selection of a route selection descriptor, RSD; and an indication for a timing for reporting the UE data.

18. The method of claim 16, wherein the UE data about URSP usage comprises at least one of the following: an identification of an application that is matched with a traffic descriptor in a plurality of URSP rules; an identification of the URSP rule that was matched; an identification of a route selection descriptor, RSD, that was matched, or a reason for rejection of the RSD for a packet data unit, PDU, session selection of the application; a timestamp for the URSP usage; and a location of the UE.

19. The method of claim 16, further comprising:
receiving an update to the URSP rule; and
storing the update to the URSP rule.

20. The method of claim 19, wherein the update comprises information indicating to the UE whether and how to send to the first network node the UE data about URSP usage,
wherein the information comprises at least one of the following: a condition for reporting the UE data; an error condition for reporting an error in a selection of a route selection descriptor, RSD, that was matched, or a reason for rejection of the RSD for a packet data unit, PDU, session selection of the application; and an indication for a timing for reporting the UE data, and
wherein the condition for reporting the UE data comprises a time and a location of the UE when and where, respectively, the UE data may be sent and a location criteria included as part of a route selection descriptor, RSD; or an access type for use in sending the UE data.

21-24. (canceled)
